(19) United States
(12) Patent Application Publication
(10) Pub. No.: US 2023/0243865 A1
(43) Pub. Date: Aug. 3, 2023

(54) Measurement Method, Sensor Device, And Inertial Measurement Device

(71) Applicant: SEIKO EPSON CORPORATION, Tokyo (JP)

(72) Inventor: Yoshiyuki MATSUURA, Shiojiri (JP)

(21) Appl. No.: 18/160,783

(22) Filed: Jan. 27, 2023

(30) Foreign Application Priority Data
Jan. 28, 2022 (JP) 2022011722

(51) Int. Cl. G01P 15/18; G01P 1/12

(52) U.S. Cl. CPC G01P 15/18; G01P 1/127

(57) ABSTRACT

A measurement method includes: an estimation step of estimating a clipping target range in first measurement data on a predetermined physical quantity measured via a first sensor device disposed in a measurement object; and a processing step of clipping the range with respect to the first measurement data.

The present application is based on, and claims priority from JP Application Serial Number 2022-011722, filed on Jan. 28, 2022, the disclosure of which is hereby incorporated by reference herein in its entirety.

### BACKGROUND

### 1. Technical Field

The present disclosure relates to a measurement method, a sensor device, and an inertial measurement device.

### 2. Related Art

When a physical quantity such as an acceleration or an angular velocity is measured, a vibration rectification error (VRE) may occur. The VRE is a phenomenon in which a response of a sensor to AC vibration is rectified to DC, and is observed as an abnormal shift in an offset of the sensor. FIG. 1 shows measurement data on an acceleration in a vertical direction when a gravitational acceleration is applied to an acceleration sensor having a measurement range of −10 [G] to +10 [G] for one second. As shown in FIG. 1, the measurement data is obtained as a waveform that oscillates around 1 G. FIG. 2 shows measurement data when a similar acceleration (gravitational acceleration) is applied to an acceleration sensor having a measurement range of −6 [G] to +6 [G]. As shown in FIG. 1, the applied acceleration has a larger component in a range of 6 [G] to 10 [G] than a component in a range of −10 [G] to −6 [G]. Therefore, in the measurement range of −6 [G] to +6 [G], a component that cannot be measured is larger in a range of 6 [G] to 10 [G] than in a range of −10 [G] to −6 [G], and the data is rounded to a value at an end of the measurement range (6 G). Therefore, as shown in FIG. 2, the measurement data on the acceleration is asymmetrically cut off at both ends (upper limit and lower limit) of the measurement range. In this way, with respect to a signal exceeding a certain value, cutting out a portion exceeding the certain value and rounding the signal to the certain value is referred to as clipping. Hereinafter, such asymmetric clipping on a plus side and a minus side is referred to as asymmetric clipping. The asymmetric clipping results in a deviation in a DC component of the measurement data. In FIG. 1, the DC component indicated by a black line is a value around 1 [G], with an average of 1 [G]. However, in FIG. 2, the DC component indicated by a black line in FIG. 2 should have been around 1 [G], but is around 0.97 [G], with an average of 0.97 [G]. That is, in FIG. 2, the DC component is deviated from a true value by 0.03 [G]. Such an error of the DC component is the VRE.

JP-A-2012-78337 discloses a system that detects an acceleration by automatically switching a measurement range of an acceleration sensor detection unit according to a magnitude of the applied acceleration. In JP-A-2012-78337, high accuracy measurement is performed with a low range setting in a stationary state, and an acceleration detection error due to VRE is prevented with a wide range setting in a vibration environment.

In JP-A-2012-78337, when a wide range mode is set, detection accuracy and a resolution of the acceleration decrease. Due to manufacturing variations in feedback capacitances of a plurality of amplifiers used to measure the acceleration in each measurement range, a gain of the amplifier may not reach a designed value, and discontinuities may occur in output data at moments when the range is switched. That is, a DC level of an output may be shifted frequently as the measurement range is switched. In this way, in JP-A-2012-78337, when the VRE is prevented, a possibility of a decrease in measurement accuracy of the physical quantity increases.

### SUMMARY

In view of the above problems, a measurement method includes: an estimation step of estimating a clipping target range in first measurement data on a predetermined physical quantity measured via a first sensor element disposed in a measurement object; and a processing step of clipping the range with respect to the first measurement data.

### BRIEF DESCRIPTION OF THE DRAWINGS

FIG. 1 is a diagram showing an example of measurement data on an acceleration.

FIG. 2 is a diagram showing an example of measurement data on an acceleration.

FIG. 3 is a diagram showing an example of a configuration of an inertial measurement device.

FIG. 4 is a diagram showing an example of a configuration of a detection circuit.

FIG. 5 is a diagram showing an example of measurement data after clipping.

FIG. 6 is a flowchart showing an example of measurement.

FIG. 7 is a diagram showing an example of a configuration of a detection circuit.

FIG. 8 is a diagram showing an example of a configuration of an inertial measurement device.

### DESCRIPTION OF EXEMPLARY EMBODIMENTS

Here, an embodiment of the present disclosure will be described in the following order.

### 1 First Embodiment

### 1-1 Configuration of Inertial Measurement Device

### 1-2 Measurement

### 2 Second Embodiment

### 2-1 Configuration of Inertial Measurement Device

### 2-2 Measurement

### 3 Third Embodiment

### 3-1 Configuration of Inertial Measurement Device

### 3-2 Measurement

### 4 Other Embodiments

### 1 First Embodiment

### 1-1 Configuration of Inertial Measurement Device

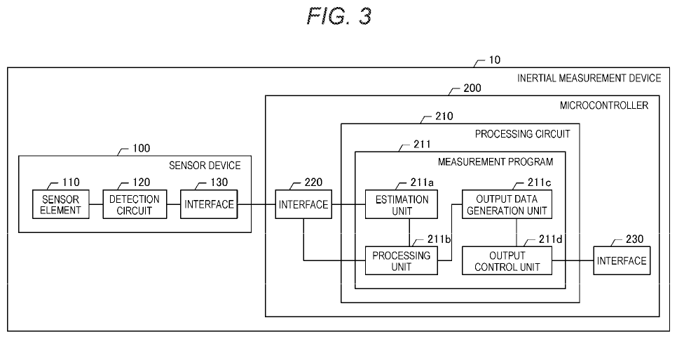

FIG. 3 is a diagram showing an example of a configuration of an inertial measurement device 10 according to the present embodiment. The inertial measurement device 10 according to the present embodiment is a device that detects a three-dimensional inertial motion (a translational motion and a rotational motion in three axial directions orthogonal to each other), and measures three-dimensional accelerations and angular velocities. The inertial measurement device 10 includes a sensor device 100 and a microcontroller 200. The sensor device 100 is used to measure a predetermined physical quantity. In the present embodiment, the predetermined physical quantity is an acceleration. The microcontroller 200 measures, via the sensor device 100 used for measuring the predetermined physical quantity, a predetermined physical quantity. The inertial measurement device 10 includes an angular velocity sensor. The microcontroller 200 measures, via these sensor devices, an angular velocity of a measurement object on which the inertial measurement device 10 is disposed.

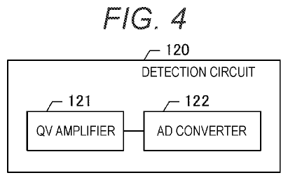

The sensor device 100 includes a sensor element 110, a detection circuit 120, and an interface 130. The sensor device 100 according to the present embodiment is an example of a first sensor device. The sensor element 110 is an element that, when receiving an acceleration, generates an electrical signal corresponding to the received acceleration. The sensor device 100 is an example of the first sensor device. The sensor element 110 can detect accelerations in three axes orthogonal to each other. In the present embodiment, a case will be described in which the sensor device 100 is disposed such that one of the three axes is directed in a vertical direction, and an acceleration in this axial direction is measured. The detection circuit 120 detects the electrical signal from the sensor element 110. As shown in FIG. 4, the detection circuit 120 includes a charge-voltage conversion amplifier (QV amplifier) 121 and an analog-to-digital (AD) converter 122. The QV amplifier 121 periodically accumulates the electrical signal from the sensor element as a charge and converts the accumulated charge into a voltage.

Accordingly, the voltage corresponding to the acceleration received by the sensor element 110 is output from the QV amplifier 121. The AD converter 122 converts a signal of the voltage output from the QV amplifier 121 into a digital signal indicating the acceleration received by the sensor element 110. The interface 130 is used for connection with the microcontroller 200. The digital signal converted by the AD converter 122 is output to the microcontroller 200 via the interface 130. In the present embodiment, a measurement range of the sensor device 100 is a range from −6 [G] to 6 [G]. Therefore, when an acceleration in a range exceeding the measurement range is applied, a vibration rectification error (VRE) may occur. The sensor device 100 measures the acceleration applied to the sensor element 110 at a measurement frequency of 10 kHz (100,000 times per second), and notifies the microcontroller 200 of measurement data on the measured acceleration via the interface 130.

The microcontroller 200 includes a processing circuit 210, an interface 220, and an interface 230.

The processing circuit 210 includes a processor, a random access memory (RAM), and a read only memory (ROM), and controls the microcontroller 200. The interface 220 is used for connection with the sensor device 100. The interface 230 is used for connection with an external device.

The processing circuit 210 functions as an estimation unit 211a, a processing unit 211b, an output data generation unit 211c, and an output control unit 211d by executing a measurement program 211 stored in the ROM.

The estimation unit 211a has a function of estimating a clipping target range in the measurement data on the predetermined physical quantity measured via the sensor element 110 of the sensor device 100 disposed in the measurement object.

By the function of the estimation unit 211a, the processing circuit 210 acquires the measurement data on the acceleration measured via the sensor device 100, and estimates, based on the acquired data, the clipping target range in the measurement data on the acceleration in the vertical direction measured via the sensor device 100. Hereinafter, details of processing related to the function of the estimation unit 211a will be described. Hereinafter, among measurement time points of the acceleration by the sensor device 100, a time point at which the measurement data to be clipped is measured is defined as tm.

The processing circuit 210 stores, in the RAM, the measurement data on the acceleration in the vertical direction notified from the sensor device 100. The processing circuit 210 acquires, from the RAM, the measurement data on the acceleration measured by the sensor device 100 in a period from a time point earlier than the time point tm by a predetermined period to the time point tm. In the present embodiment, the predetermined period is 0.1 seconds. The measurement data on the acceleration measured in the period from (time point tm—0.1 seconds) to the time point tm in the present embodiment is an example of second measurement data. The processing circuit 210 obtains, as an analogous value of a DC component of the acceleration at the time point tm, an average value of the acquired measurement data on the acceleration, that is, a value of a backward moving average of the acceleration at the time point tm. Hereinafter, the analogous value is referred to as a DC analogous value. The DC analogous value is obtained based on the acceleration measured in the measurement range of −6 [G] to 6 [G]. Therefore, in the DC analogous value, when the acceleration exceeding the measurement range occurs, asymmetric clipping may occur and the VRE may occur. The DC analogous value is considered to be a value that is approximate to a true value of the DC component of the acceleration at the time point tm to some extent even when being affected by the asymmetric clipping. Therefore, in the present embodiment, the processing circuit 210 rounds the measurement data on the acceleration measured via the sensor device 100 within a range of a predetermined width around the DC analogous value. In the present embodiment, this range is a range of ±5 [G] around the DC analogous value (a range of (DC analogous value−5 [G]) to (DC analogous value+5 [G])). The processing circuit 210 estimates a range exceeding this range, that is, a range smaller than (DC analogous value−5 [G]) and a range larger than (DC analogous value+5 [G]) as a clipping target range in the measurement data on the acceleration in the vertical direction measured via the sensor device 100. Hereinafter, the estimated range is referred to as the clipping target range. The processing circuit 210 executes the above processing every time the measurement data on the acceleration is received from the sensor device 100.

The processing unit 211b has a function of clipping the clipping target range estimated by the function of the estimation unit 211a, with respect to the measurement data measured via the sensor device 100.

By the function of the processing unit 211b, the processing circuit 210 clips the clipping target range with respect to the measurement data on the acceleration in the vertical direction measured at the time point tm via the sensor device 100. The measurement data on the acceleration measured at the time point tm by the sensor device 100 according to the present embodiment is an example of first measurement data. More specifically, when the measurement data measured at the time point tm is within a range of (DC analogous value−5 [G]) to (DC analogous value+5 [G]), the processing circuit 210 maintains the measurement data as it is. When the measurement data measured at the time point tm is smaller than (DC analogous value−5 [G]), the processing circuit 210 sets the value to (DC analogous value−5 [G]). When the measurement data measured at the time point tm is larger than (DC analogous value+5 [G]), the processing circuit 210 sets the value to (DC analogous value+5 [G]).

Then, the processing circuit 210 stores the clipped measurement data in the RAM in association with the measurement time point tm.

The processing circuit 210 executes the above processing every time the estimation unit 211a executes processing of estimating the clipping target range. Accordingly, the clipped measurement data on the acceleration is sequentially stored in the RAM in association with the measurement time point. That is, time-series data that is the clipped measurement data on the acceleration is obtained.

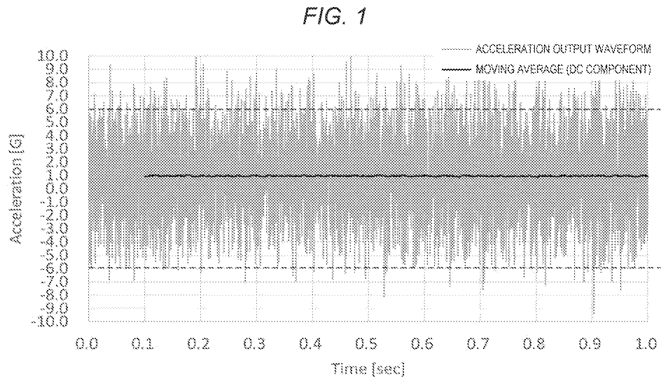

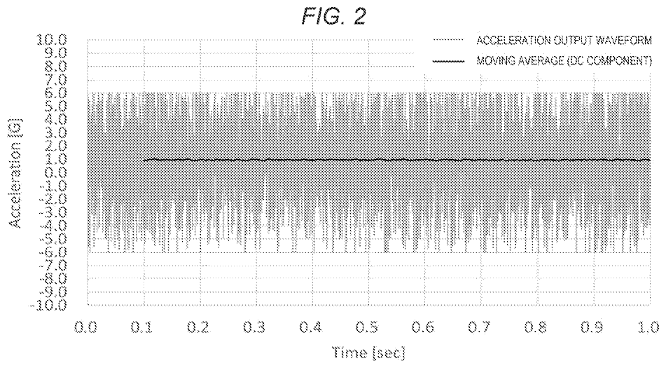

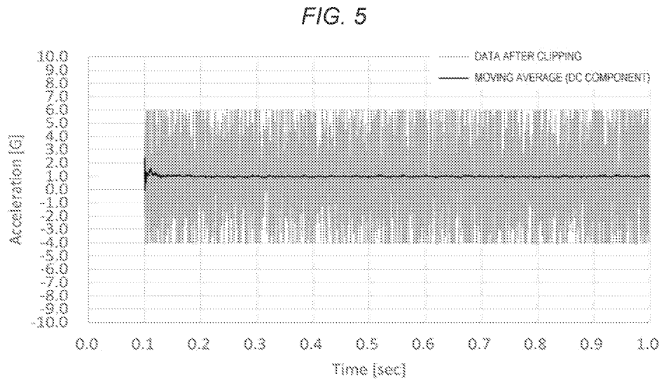

Here, time-series data stored by the function of the processing unit 211b when an acceleration (gravitational acceleration) similar to that in FIG. 1 is applied to the sensor element 110 will be described with reference to FIG. 5. In this case, measurement data measured via the sensor device 100 is the same as that in FIG. 2. Therefore, the processing circuit 210 obtains, as a DC analogous value, each data on a DC component shown in FIG. 2. The processing circuit 210 clips a range exceeding a DC analogous value±5 [G] from the measurement data on the acceleration, and stores the clipped data as time-series data in association with a measurement time point. In this case, as shown in FIG. 5, the stored time-series data is data rounded to a range of data on the DC component in FIG. 2±5 [G]. As shown in FIG. 5, it can be seen that the data after cutting out by clipping is more approximate to vertical symmetry than in FIG. 2. A black line in FIG. 5 indicates a backward moving average of the time-series data having a width of 0.1 seconds. An average value of the black line in FIG. 5 is 0.999. A DC component of the acceleration in FIG. 1 is approximately 1. Therefore, it can be seen that a DC component of the data in FIG. 5 is approximate to a true value and a VRE is less likely to occur as compared with data in FIG. 2.

The output data generation unit 211c has a function of generating data to be output to the external device. In the present embodiment, by the function of the output data generation unit 211c, the processing circuit 210 acquires, from the RAM, as the time-series data, the measurement data clipped by the function of the processing unit 211b, the measurement data being measured in the period from the time point earlier than the time point tm by the predetermined period to the time point tm. The processing circuit 210 generates, as output data, data obtained by applying a predetermined low-pass filter to the acquired time-series data. In the present embodiment, the predetermined low-pass filter is a backward moving average having a filter width of 0.1 seconds, but may be another filter. In the present embodiment, the processing circuit 210 rounds the output data to a range of −4 [G] to +4 [G]. That is, the processing circuit 210 clips a range smaller than −4 [G] and a range larger than +4 [G] with respect to the output data. As another example, the processing circuit 210 may or may not clip other ranges such as a range smaller than −3 [G] and a range larger than +3 [G] with respect to the output data. For example, when the acceleration similar to that in FIG. 1 is applied to the sensor element 110, the output data generated by the function of the output data generation unit 211c is a value at each time point of the DC component indicated by the black line in FIG. 5.

The output control unit 211d has a function of outputting, to the external device, the output data generated by the function of the output data generation unit 211c. By the function of the output control unit 211d, the processing circuit 210 outputs, to the external device, the output data generated by the function of the output data generation unit 211c via the interface 230.

As described above, according to the configuration of the present embodiment, the inertial measurement device 10 estimates the clipping target range in the measurement data on the acceleration measured via the sensor element 110, and clips the estimated range from the measurement data. Accordingly, the inertial measurement device 10 can clip the measurement data in a more vertically symmetrical manner. By using the clipped data in this way, it is possible to obtain the value of the DC component with less VRE. In the inertial measurement device 10, since it is not necessary to switch the measurement range of the sensor device 100, measurement accuracy does not decrease due to the switching of the measurement range. That is, the inertial measurement device 10 can reduce the VRE while reducing a possibility of a decrease in measurement accuracy.

In the present embodiment, the inertial measurement device 10 obtains the DC analogous value from the measurement data measured during 0.1 seconds before the time point tm, and estimates the clipping target range based on the obtained DC analogous value. The DC analogous value may cause the asymmetric clipping, but is considered as approximate to the true value of the DC component to some extent. The inertial measurement device 10 estimates the clipping target range based on the DC analogous value that is approximate to the true value of the DC component to some extent in this way. Accordingly, the measurement data to be clipped is rounded to the range of ±5 [G] around the DC analogous value, and a possibility of being clipped in a vertically asymmetrical manner is reduced. That is, the inertial measurement device 10 can reduce asymmetry of portions clipped at both ends of the measurement range in the measurement data, and can reduce the VRE.

### 1-2 Measurement

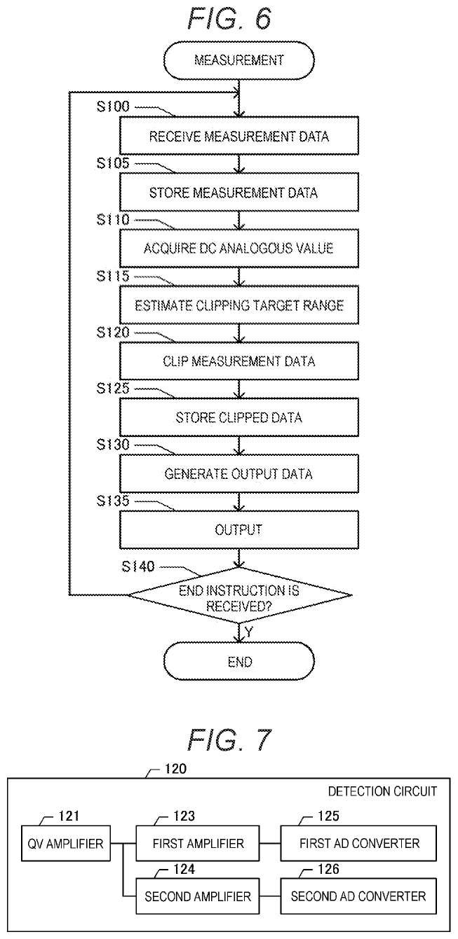

Measurement executed by the inertial measurement device 10 will be described with reference to FIG. 6.

When receiving an instruction to start processing from an external device via the interface 230, the processing circuit 210 instructs the sensor device 100 to measure an acceleration, and starts the processing in FIG. 6.

In step S100, by the function of the estimation unit 211a, the processing circuit 210 receives measurement data on the acceleration in the vertical direction from the sensor device 100 via the interface 220. Here, a measurement time point of the received measurement data is defined as the time point tm at which the measurement data to be clipped is measured. After completion of the processing in step S100, the processing circuit 210 advances the processing to step S105.

In step S105, by the function of the estimation unit 211a, the processing circuit 210 stores the measurement data received in step S100 in the RAM. After completion of the processing in step S105, the processing circuit 210 advances the processing to step S110.

In step S110, by the function of the estimation unit 211a, the processing circuit 210 acquires, from the RAM, the measurement data on the acceleration measured by the sensor device 100 in a period from a time point earlier than the time point tm by a predetermined period (0.1 seconds) to the time point tm. Then, the processing circuit 210 acquires, as a DC analogous value at the time point tm, an average value of the acquired measurement data on the acceleration, that is, a value of a backward moving average of the acceleration at the time point tm. After completion of the processing in step S110, the processing circuit 210 advances the processing to step S115. When the measurement data on the acceleration measured in the period from the time point earlier than the time point tm by the predetermined period to the time point tm is not stored in the RAM, the processing circuit 210 advances the processing to step S140.

In step S115, by the function of the estimation unit 211a, the processing circuit 210 estimates a range smaller than (DC analogous value−5 [G]) and a range larger than (DC analogous value+5 [G]) as a clipping target range based on the DC analogous value acquired in the immediately preceding step S110. After completion of the processing in step S115, the processing circuit 210 advances the processing to step S120. The processing of steps S110 to S115 is an example of estimation.

In step S120, by the function of the processing unit 211b, the processing circuit 210 clips the clipping target range with respect to the measurement data measured at the time point tm acquired in the immediately preceding step S100. After completion of the processing in step S120, the processing circuit 210 advances the processing to step S125. Step S120 is an example of a processing step.

In step S125, by the function of the processing unit 211b, the processing circuit 210 stores, in the RAM, the clipped measurement data acquired in the immediately preceding step S120 in association with the measurement time point tm. After completion of the processing in step S125, the processing circuit 210 advances the processing to step S130.

In step S130, by the function of the output data generation unit 211c, the processing circuit 210 acquires, from the RAM, as time-series data, measurement data associated with a time point in the period from the time point earlier than the time point tm by the predetermined period (0.1 seconds) to the time point tm, in the clipped measurement data stored in step S125. The processing circuit 210 generates, as output data, data obtained by applying a predetermined low-pass filter to the acquired time-series data. The processing circuit 210 clips a range smaller than −4 [G] and a range larger than +4 [G] with respect to the output data. After completion of the processing in step S130, the processing circuit 210 advances the processing to step S135. When the clipped measurement data measured in the period from the time point earlier than the time point tm by the predetermined period to the time point tm is not stored in the RAM, the processing circuit 210 advances the processing to step S140.

In step S135, by the function of the output control unit 211d, the processing circuit 210 outputs the output data generated in the immediately preceding step S130 by transmitting the output data to the external device via the interface 230. After completion of the processing in step S135, the processing circuit 210 advances the processing to step S140.

In step S140, by the function of the output control unit 211d, the processing circuit 210 determines whether an instruction to end the measurement is received from the external device. When determining that the instruction to end the measurement is received from the external device, the processing circuit 210 completes the processing in FIG. 6. When determining that the instruction to end the measurement is not received from the external device, the processing circuit 210 advances the processing to step S100.

### 2 Second Embodiment

### 2-1 Configuration of Inertial Measurement Device

A second embodiment will be described. The inertial measurement device 10 according to the second embodiment is different from that according to the first embodiment in a configuration of the detection circuit 120.

The configuration of the detection circuit 120 according to the present embodiment will be described with reference to FIG. 7.

The detection circuit 120 according to the present embodiment includes the QV amplifier 121, a first amplifier 123, a second amplifier 124, a first AD converter 125, and a second AD converter 126. The QV amplifier 121 is the same as that according to the first embodiment. The first amplifier 123 amplifies a voltage signal output from the QV amplifier 121 with a predetermined amplification factor. The second amplifier 124 amplifies a voltage signal output from the QV amplifier 121 with a predetermined amplification factor smaller than that of the first amplifier 123. The first AD converter 125 converts the voltage signal output from the first amplifier 123 into a digital signal indicating a corresponding acceleration, and transmits the digital signal to the microcontroller 200 via the interface 130. The second AD converter 126 converts the voltage signal output from the second amplifier 124 into a digital signal indicating a corresponding acceleration, and transmits the digital signal to the microcontroller 200 via the interface 130. In the present embodiment, the first amplifier 123 and the first AD converter 125, and the second amplifier 124 and the second AD converter 126 respectively amplify voltage signals from the QV amplifier 121 in parallel, and convert the amplified voltage signals into digital signals indicating accelerations. That is, the sensor device 100 measures the accelerations in parallel via the first amplifier 123 and the second amplifier 124.

The amplification factor of the first amplifier 123 is larger than that of the second amplifier 124. Therefore, even when the voltage signals indicate the same acceleration, the voltage signal amplified by the first amplifier 123 is larger than the voltage signal amplified by the second amplifier 124. There is a limit value (an upper limit value and/or a lower limit value) of a voltage that can be converted into a digital signal by the first AD converter 125 or the second AD converter 126. A voltage signal exceeding the limit value is rounded to the limit value. That is, the voltage signal is not converted into digital data correctly indicating a corresponding acceleration. The voltage signal amplified by the first amplifier 123 has a larger portion exceeding the limit value than the voltage signal amplified by the second amplifier 124. As a result, the second amplifier 124 can be used to measure the acceleration in a measurement range larger than that when the first amplifier 123 is used. Therefore, the second amplifier 124 can be used to reduce asymmetric clipping more than when the first amplifier 123 is used. On the other hand, since the amplification factor of the first amplifier 123 is larger than that of the second amplifier 124, the first amplifier 123 can be used to measure an acceleration that is less affected by noise than when the second amplifier 124 is used.

Next, functions and processing of the microcontroller 200 according to the present embodiment will be described. Processing executed by the estimation unit 211a and the processing unit 211b according to the present embodiment is different from that according to the first embodiment.

In the present embodiment, by a function of the estimation unit 211a, the processing circuit 210 acquires measurement data on an acceleration in the vertical direction measured via the sensor device 100, that is, via the second amplifier 124. Then, the processing circuit 210 stores the acquired measurement data in the RAM. The processing circuit 210 acquires, from the RAM, the measurement data on the acceleration in the vertical direction measured via the second amplifier 124 in a period from a time point earlier than the time point tm by a predetermined period to the time point tm. In the present embodiment, the predetermined period is 0.1 seconds. The measurement data on the acceleration measured via the second amplifier 124 in the period from (time point tm −0.1 seconds) to the time point tm in the present embodiment is an example of second measurement data. The processing circuit 210 obtains, as a DC analogous value at the time point tm, an average value of the acquired measurement data on the acceleration, that is, a value of a backward moving average of the acceleration at the time point tm. The processing circuit 210 estimates a range exceeding a range of ±5 [G] around the DC analogous value, that is, a range smaller than (DC analogous value−5 [G]) and a range larger than (DC analogous value+5 [G]) as a clipping target range of the measurement data on the acceleration in the vertical direction measured via the first amplifier 123. The processing circuit 210 executes the above processing every time the measurement data on the acceleration is received from the sensor device 100.

In the present embodiment, by a function of the processing unit 211b, the processing circuit 210 receives, from the sensor device 100, the measurement data on the acceleration in the vertical direction measured at the time point tm via the first amplifier 123 of the sensor device 100. The processing circuit 210 clips the clipping target range with respect to the received measurement data. The measurement data on the acceleration measured at the time point tm via the first amplifier 123 according to the present embodiment is an example of first measurement data. Then, the processing circuit 210 stores the clipped measurement data in the RAM in association with the measurement time point tm.

The processing circuit 210 executes the above processing every time the estimation unit 211a executes processing of estimating the clipping target range. Accordingly, the clipped measurement data on the acceleration is sequentially stored in the RAM in association with the measurement time point. That is, time-series data of the clipped measurement data on the acceleration is obtained.

As in the first embodiment, the processing circuit 210 generates output data by a function of the output data generation unit 211c, and outputs the output data to an external device via the interface 230 by a function of the output control unit 211d.

As described above, according to a configuration of the present embodiment, the inertial measurement device 10 obtains the DC analogous value based on the measurement data measured via the second amplifier 124, which is capable of measuring the acceleration in the measurement range larger than that of the first amplifier 123, and estimates the clipping target range based on the obtained DC analogous value. The inertial measurement device 10 can estimate a clipping target range that is less affected by the asymmetric clipping than when using measurement data measured via the first amplifier 123. Accordingly, the inertial measurement device 10 can reduce asymmetry of the clipped portion in the measurement data measured via the first amplifier 123. The inertial measurement device 10 clips the measurement data measured via the first amplifier 123 having less noise than the second amplifier 124. Accordingly, the inertial measurement device 10 can reduce noise in the output data.

### 2-2 Measurement

Measurement executed by the inertial measurement device 10 according to the present embodiment will be described with reference to FIG. 6.

In step S100, by the function of the estimation unit 211a, the processing circuit 210 receives, from the sensor device 100 via the interface 220, measurement data on an acceleration in the vertical direction measured via the first amplifier 123 and measurement data on an acceleration in the vertical direction measured via the second amplifier 124. Here, a measurement time point of the received measurement data is defined as the time point tm at which the measurement data to be clipped is measured. After completion of the processing in step S100, the processing circuit 210 advances the processing to step S105.

In step S105, by the function of the estimation unit 211a, the processing circuit 210 stores, in the RAM, the measurement data on the acceleration measured via the second amplifier 124 received in step S100. After completion of the processing in step S105, the processing circuit 210 advances the processing to step S110.

In step S110, by the function of the estimation unit 211a, the processing circuit 210 acquires, from the RAM, the measurement data on the acceleration measured via the second amplifier 124 in a period from a time point earlier than the time point tm by a predetermined period (0.1 seconds) to the time point tm. Then, the processing circuit 210 acquires, as a DC analogous value at the time point tm, an average value of the acquired measurement data on the acceleration, that is, a value of a backward moving average of the acceleration at the time point tm. After completion of the processing in step S110, the processing circuit 210 advances the processing to step S115. When the measurement data on the acceleration measured in the period from the time point earlier than the time point tm by the predetermined period to the time point tm is not stored in the RAM, the processing circuit 210 advances the processing to step S140.

The processing in step S115 is the same as that according to the first embodiment. After completion of the processing in step S115, the processing circuit 210 advances the processing to step S120.

In step S120, by the function of the processing unit 211b, the processing circuit 210 clips the clipping target range with respect to the measurement data measured via the first amplifier 123 acquired in the immediately preceding step S100. After completion of the processing in step S120, the processing circuit 210 advances the processing to step S125.

The processing in steps S125 to S140 are the same as those according to the first embodiment.

### 3 Third Embodiment

### 3-1 Configuration of Inertial Measurement Device

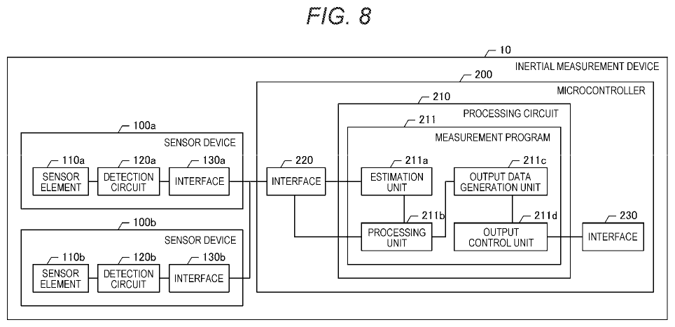

A third embodiment will be described. FIG. 8 shows a configuration of the inertial measurement device 10 according to the present embodiment. The inertial measurement device 10 according to the present embodiment is different from that according to the first embodiment in that two sensor devices 100a, 100b are provided as the sensor device 100.

Each of the sensor devices 100a, 100b is a sensor device having the same configuration as that of the sensor device 100 according to the first embodiment, but the sensor device 100b has an acceleration measurement range larger than that of the sensor device 100a. The sensor device 100a according to the present embodiment is an example of a first sensor device. The sensor device 100b according to the present embodiment is an example of a second sensor device.

In the present embodiment, the sensor device 100a and the sensor device 100b measure accelerations in parallel.

Next, functions and processing of the microcontroller 200 according to the present embodiment will be described. Processing executed by the estimation unit 211a and the processing unit 211b according to the present embodiment is different from that according to the first embodiment.

In the present embodiment, by a function of the estimation unit 211a, the processing circuit 210 acquires measurement data on an acceleration in the vertical direction measured via the sensor device 100b. Then, the processing circuit 210 stores the acquired measurement data in the RAM. The processing circuit 210 acquires, from the RAM, the measurement data on the acceleration in the vertical direction measured via the sensor device 100b in a period from a time point earlier than the time point tm by a predetermined period to the time point tm. In the present embodiment, the predetermined period is 0.1 seconds. The measurement data on the acceleration measured via the sensor device 100b in the period from (time point tm—0.1 seconds) to the time point tm in the present embodiment is an example of third measurement data. The processing circuit 210 obtains, as a DC analogous value at the time point tm, an average value of the acquired measurement data on the acceleration. The processing circuit 210 estimates a range exceeding a range of ±5 [G] around the DC analogous value, that is, a range smaller than (DC analogous value−5 [G]) and a range larger than (DC analogous value+5 [G]) as a clipping target range of measurement data on an acceleration measured via the sensor device 100a. The processing circuit 210 executes the above processing every time the measurement data on the acceleration is received from the sensor device 100.

In the present embodiment, by a function of the processing unit 211b, the processing circuit 210 receives, from the sensor device 100, the measurement data measured at the time point tm via the sensor device 100a. The processing circuit 210 clips the clipping target range with respect to the received measurement data. The measurement data on the acceleration measured at the time point tm via the sensor device 100a according to the present embodiment is an example of first measurement data. Then, the processing circuit 210 stores the clipped measurement data in the RAM in association with the measurement time point tm.

The processing circuit 210 executes the above processing every time the estimation unit 211a executes processing of estimating the clipping target range. Accordingly, the clipped measurement data on the acceleration is sequentially stored in the RAM in association with the measurement time point. That is, time-series data that is the clipped measurement data on the acceleration is obtained.

As in the first embodiment, the processing circuit 210 generates output data by a function of the output data generation unit 211c, and outputs the output data to an external device via the interface 230 by a function of the output control unit 211d.

As described above, according to a configuration of the present embodiment, the inertial measurement device 10 estimates the clipping target range based on the measurement data measured via the sensor device 100b, which has a larger measurement range and is less affected by asymmetric clipping than the sensor device 100a. In this way, the inertial measurement device 10 can estimate a clipping target range that is less affected by the asymmetric clipping than when using the measurement data measured via the sensor device 100a. Accordingly, the inertial measurement device 10 can reduce asymmetry of the clipped portion in the measurement data measured via the sensor device 100a.

### 3-2 Measurement

Measurement executed by the inertial measurement device 10 according to the present embodiment will be described with reference to FIG. 6.

In step S100, by the function of the estimation unit 211a, the processing circuit 210 receives, from the sensor device 100 via the interface 220, measurement data on an acceleration in the vertical direction measured via the sensor device 100a and measurement data on an acceleration in the vertical direction measured via the sensor device 100b. Here, a measurement time point of the received measurement data is defined as the time point tm at which the measurement data to be clipped is measured. After completion of the processing in step S100, the processing circuit 210 advances the processing to step S105.

In step S105, by the function of the estimation unit 211a, the processing circuit 210 stores, in the RAM, the measurement data measured via the sensor device 100b received in step S100. After completion of the processing in step S105, the processing circuit 210 advances the processing to step S110.

In step S110, by the function of the estimation unit 211a, the processing circuit 210 acquires, from the RAM, the measurement data on the acceleration measured via the sensor device 100b in a period from a time point earlier than the time point tm by a predetermined period (0.1 seconds) to the time point tm. Then, the processing circuit 210 acquires, as a DC analogous value at the time point tm, an average value of the acquired measurement data on the acceleration, that is, a value of a backward moving average of the acceleration at the time point tm. After completion of the processing in step S110, the processing circuit 210 advances the processing to step S115. When the measurement data on the acceleration measured in the period from the time point earlier than the time point tm by the predetermined period to the time point tm is not stored in the RAM, the processing circuit 210 advances the processing to step S140.

The processing in step S115 is the same as that according to the first embodiment. After completion of the processing in step S115, the processing circuit 210 advances the processing to step S120.

In step S120, by the function of the processing unit 211b, the processing circuit 210 clips the clipping target range with respect to the measurement data measured via the sensor device 100a acquired in the immediately preceding step S100. After completion of the processing in step S120, the processing circuit 210 advances the processing to step S125.

The processing in steps S125 to S140 are the same as those according to the first embodiment.

### 4 Other Embodiments

The above embodiments are examples for carrying out the present disclosure, and various other embodiments may be adopted. For example, the inertial measurement device 10 includes the sensor device 100 and the microcontroller 200 in each of the embodiments described above, but may not include the sensor device 100. In this case, the inertial measurement device 10 acquires measurement data on an acceleration from the sensor device 100 disposed outside.

In each of the embodiments described above, the inertial measurement device 10 measures the measurement data on the acceleration in the vertical direction as a clipping target. On the other hand, the inertial measurement device 10 may measure measurement data on an acceleration in another direction as a clipping target. For example, the inertial measurement device 10 may measure measurement data on an acceleration in a direction parallel to a horizontal direction. In this case, for example, the processing circuit 210 estimates a clipping target range based on the measurement data on the acceleration in this direction, and clips the clipping target range with respect to the measurement data on the acceleration in this direction. Alternatively, the inertial measurement device 10 may execute processing of measuring measurement data on an acceleration in each of a plurality of directions, estimating a clipping target range for the measurement data on the acceleration in each direction, and clipping the clipping target range in the measurement data.

The sensor device 100 is disposed such that one of the three axes in which the acceleration can be detected is directed in the vertical direction in each of the embodiments described above, but the sensor device 100 may be disposed in another form. For example, the sensor device 100 may be disposed on a moving body or the like that moves on a slope or the like.

The sensor element 110 of the sensor device 100 is an element that detects the acceleration in each of the embodiments described above, but may be an element that detects other physical quantities such as an angular velocity. Then, the processing circuit 210 may estimate a clipping target range for measurement data on other physical quantities such as the angular velocity detected by the sensor element 110, and perform clipping. The sensor device 100 is a device that detects a physical quantity via the sensor element 110 and outputs digital data indicating the detected physical quantity in each of the embodiments described above, but the sensor device 100 may also implement functions of the estimation unit 211a and the processing unit 211b of the microcontroller 200. In this case, the sensor device 100 includes the microcontroller 200, and estimates a clipping target range based on measurement data output from the detection circuit 120 by the function of the estimation unit 211a. Then, the sensor device 100 clips the clipping target range with respect to the measurement data output from the detection circuit 120 by the function of the processing unit 211b. Thereafter, the sensor device 100 may output the clipped measurement data to an external device.

In each of the embodiments described above, the processing circuit 210 estimates the clipping target range based on the measurement data on the acceleration measured by the sensor device 100 in the period from the time point earlier than the time point tm by the predetermined period to the time point tm. That is, the processing circuit 210 estimates the clipping target range based on the measurement data measured before the measurement time point of the measurement data to be clipped. On the other hand, the processing circuit 210 may estimate the clipping target range based on other measurement data as long as the measurement data is measured before the measurement data to be clipped. For example, the processing circuit 210 may obtain, as a DC analogous value, a moving average value of data on the acceleration measured by the sensor device 100 in a period before the time point tm, and estimate the clipping target range based on the obtained DC analogous value. For example, the processing circuit 210 may estimate the clipping target range based on the data on the acceleration measured by the sensor device 100 in a period from a time point 0.2 seconds before the time point tm to a time point 0.1 seconds before the time point tm.

The processing circuit 210 estimates the range outside the range of the DC analogous value±5 [G] as the clipping target range in each of the embodiments described above, but the processing circuit 210 may estimate another range as the clipping target range. For example, the processing circuit 210 may estimate, as the clipping target range, a range outside a range of a DC analogous value±3 [G] (a range larger than the DC analogous value+3 [G] and a range smaller than the DC analogous value−3 [G]), a range of ±4 [G] around the DC analogous value, or the like.

Assume the measurement range of the sensor device 100 for measuring the measurement data on the acceleration to be clipped is ±N [G] (N is a positive value), and a value obtained by subtracting an absolute value of the DC analogous value from N is X. The processing circuit 210 may estimate a range outside a range of a DC analogous value±X [G] (a range larger than the DC analogous value+X [G] and a range smaller than the DC analogous value−X [G]) as the clipping target range. Accordingly, the processing circuit 210 can prevent a situation in which a value of the measurement data to be clipped is saturated in a region other than the end portion within the clipping target range. The processing circuit 210 may select a value having an absolute value smaller than X and estimate a range outside a range of the DC analogous value±the selected value as the clipping target range.

The present disclosure can also be applied as a program or a method executed by a computer. In addition, a system, a program, and a method as described above may be implemented as a single device or may be implemented using components provided in a plurality of devices, and include various aspects. For example, the configuration may be changed as appropriate such that a part of the configuration is software and a part of the configuration is hardware. Further, the present disclosure is also applicable to a recording medium of a program for controlling an information processing device. As a matter of course, the recording medium of the program may be a magnetic recording medium or a semiconductor memory, or may be any recording medium developed in the future.

What is claimed is:

1. A measurement method comprising:
an estimation step of estimating a clipping target range in first measurement data on a predetermined physical quantity measured via a first sensor device disposed in a measurement object; and
a processing step of clipping the range with respect to the first measurement data.

2. The measurement method according to claim 1, wherein
in the estimation step, the range is estimated based on a DC component of second measurement data measured before a measurement time point of the first measurement data via the first sensor device.

3. The measurement method according to claim 2, wherein
the first sensor device includes a sensor element, a first amplifier configured to amplify a signal from the sensor element, and a second amplifier configured to amplify a signal from the sensor element with an amplification factor smaller than that of the first amplifier,
the first measurement data is obtained by amplifying the signal from the sensor element by the first amplifier, and
the second measurement data is obtained by amplifying the signal from the sensor element by the second amplifier.

4. The measurement method according to claim 1, wherein
in the estimation step, the range is estimated based on a DC component of third measurement data measured before a measurement time point of the first measurement data via a second sensor device having a measurement range larger than that of the first sensor device.

5. A sensor device comprising:
a sensor element used to measure a predetermined physical quantity;
an estimation unit configured to estimate a clipping target range in measurement data on the predetermined physical quantity measured via the sensor element; and
a processing unit configured to clip the range with respect to the measurement data.

6. An inertial measurement device comprising:
a sensor device used to measure a predetermined physical quantity;
an estimation unit configured to estimate a clipping target range in measurement data on the predetermined physical quantity measured via the sensor device; and
a processing unit configured to execute processing of clipping the range with respect to the measurement data.
